(19) United States
(12) Patent Application Publication
(10) Pub. No.: US 2017/0056940 A1
(43) Pub. Date: Mar. 2, 2017

(54) System for Cleaning a Limited Access Holding Tank

(71) Applicant: Gary Segler, Grover Beach, CA (US)

(72) Inventor: Gary Segler, Grover Beach, CA (US)

(21) Appl. No.: 15/213,375

(22) Filed: Jul. 18, 2016

Related U.S. Application Data
(60) Provisional application No. 62/283,392, filed on Aug. 31, 2015.

(51) Int. Cl. B08B 9/093; B08B 15/00

(52) U.S. Cl. CPC B08B 9/093; B08B 15/00

(57) ABSTRACT

A holding tank cleaning system is provided for minimizing the splatter of undesirable materials stored in the holding tank, where the system includes a sealing member having a generally frusto-conical shape and having an inner core for permitting the passage of fluid therethrough, a supply member connectable to a source of fluid and configured to movably fit within the inner core of the sealing member; and a distribution member configured to movably fit within the inner core of the sealing member, the distribution member having a distribution chamber with a plurality of openings such that fluid directed from the supply member through the sealing member into the distribution member can be directed radially outwardly in a direction generally perpendicular to the direction of fluid passing through the supply chamber.

### CORRESPONDING PATENT APPLICATIONS

The present application takes priority from provisional application Ser. No. 62/283,392 filed Aug. 31, 2015, the entire contents of which are incorporated herein in its entirety by reference.

### BACKGROUND

The present invention relates to systems for cleaning out holding tanks that have minimal access generally, where embodiments of the invention provide for cleaning while minimizing splatter of undesirable materials that were stored in the holding tanks.

In recreational vehicles, holding tanks are used in associated with toilets for storing waste until the waste can be disposed appropriately. Presently that are products available for cleaning the holding tank after disposing of the waste contents, but those products have the potential, and often result, in some splatter of the residual waste contents either onto the person doing the cleaning or to adjacent surfaces within the recreational vehicle. A need exists for the ability to clean the holding tank while minimizing, if not eliminating, the splatter of undesirable materials that were stored in the holding tanks.

### SUMMARY

A holding tank cleaning system is provided for minimizing the splatter of undesirable materials stored in the holding tank, where the holding tank is fluidly connected via a fluid passageway to a bowl into which waste material is deposited, the fluid passageway having a valve therein. In some embodiments, the system comprises a sealing member having a generally frusto-conical shape and comprising an inner core for permitting the passage of fluid therethrough, the sealing member configured to connect to a source of fluid; a supply member connectable to a source of fluid and configured to movably fit within the inner core of the sealing member; and a distribution member configured to movably fit within the inner core of the sealing member, the distribution member comprising a distribution chamber comprising a plurality of openings such that fluid directed from the supply member through the sealing member into the distribution member can be directed radially outwardly in a direction generally perpendicular to the direction of fluid passing through the supply chamber. In some embodiments of a holding tank cleaning system, the distribution member is configured to be connectable to the supply member so that both can move in unison within the inner core of the sealing member. In some embodiment of the holding tank cleaning, the supply member comprises a valve to regular the flow of fluid into the system. In some embodiments of the holding tank cleaning system, the sealing member comprises a detent for engaging a surface that extends radially inwardly from an outer surface of the sealing member. In other embodiments, the sealing member comprises a plurality of detents.

### BRIEF DESCRIPTION OF THE FIGURES

The aforementioned objects and advantages of the present invention, as well as additional objects and advantages thereof, will be more fully understood hereinafter as a result of a detailed description of a preferred embodiment when taken in conjunction with the following drawings in which:

FIG. 1 shows a schematic perspective view of one embodiment 10 of the present invention;

FIG. 2 shows an exploded schematic perspective view of the embodiment of FIG. 1;

FIG. 3 shows a schematic elevational view of an alternative embodiment 110 as applied to an existing toilet bowl (B) and holding tank (HT).

### DETAILED DESCRIPTION OF CERTAIN EMBODIMENTS

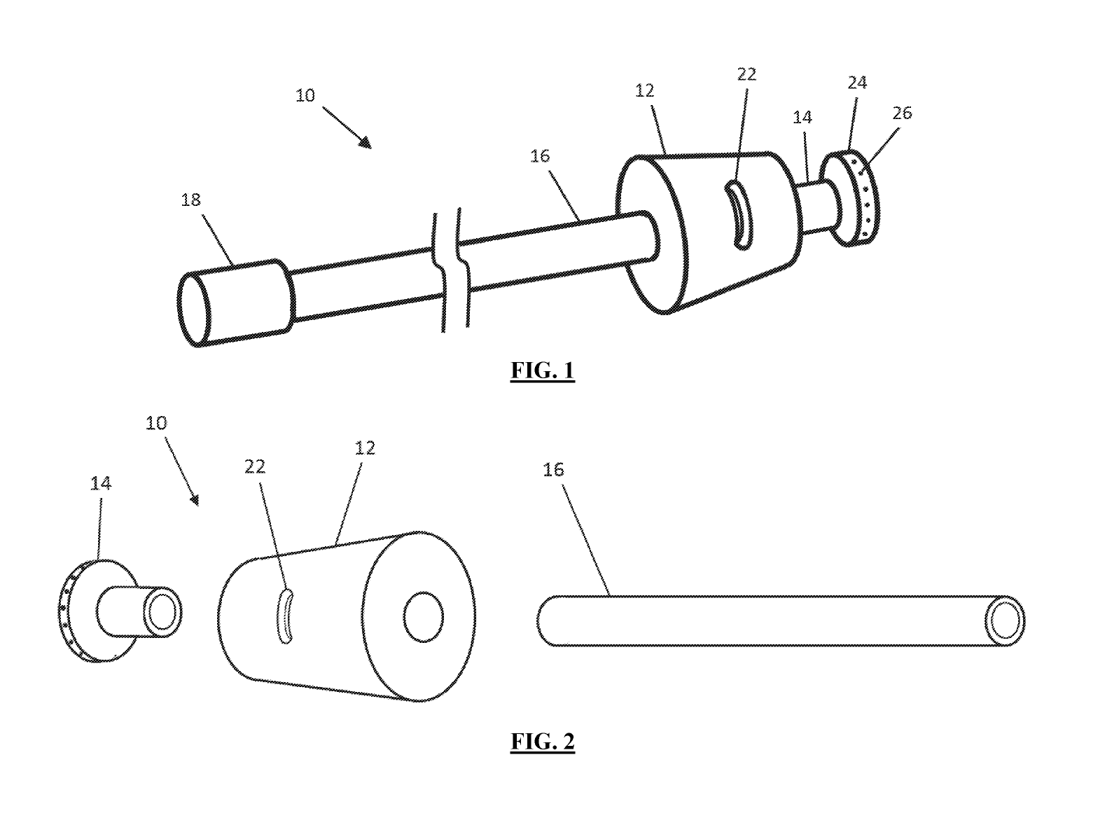

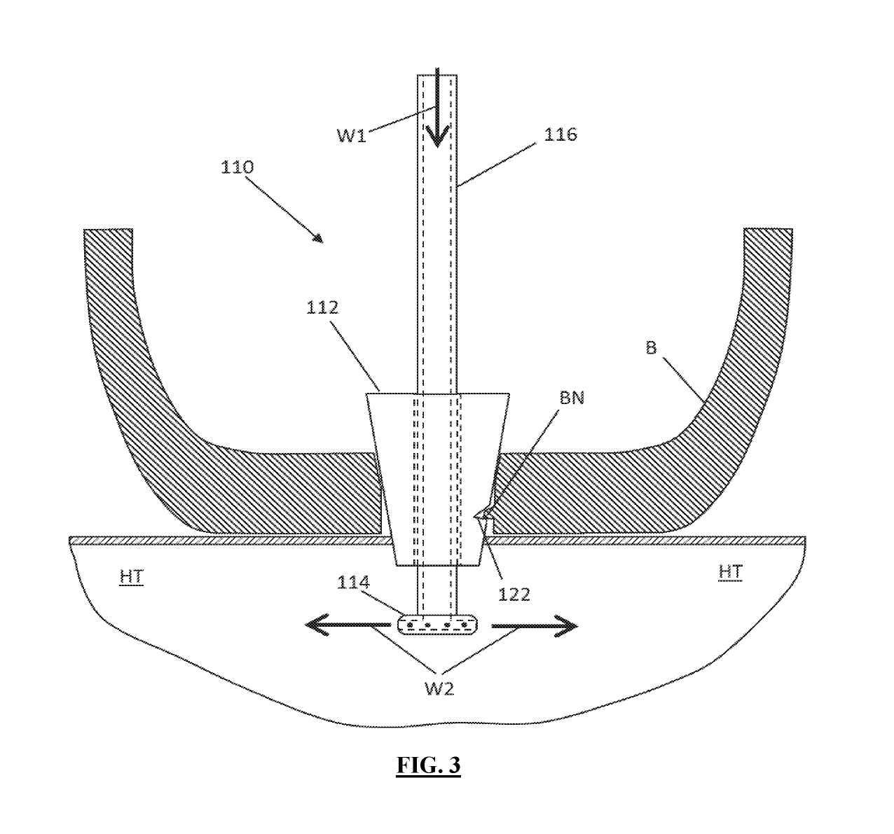

By way of example, and referring to FIGS. 1 and 2, one embodiment of the present invention comprises a system 10 that itself comprises a generally frusto-conical sealing member 12 having a hollow core to permit the insertion at opposing ends of a distribution member 14 and a fluid supply member 16, which may be provided with, or is configured to connect to, a valved connector 18 to regulate the supply of fluid through the system when desired. The outer diameter of the distribution member 14 and a fluid supply member 16 are such as to permit a tight friction fit into the hollow core of the sealing member 12. The distribution member 14 and the fluid supply member 16 also comprise hollow cores to permit the flow of fluid through the system. In some embodiments, such as system embodiment 10, the sealing member 12 also comprises a detent or slot 22 for securing the sealing member 12 into place when the system 10 is in use, as discussed below in association with FIG. 3. It is contemplated that some embodiments may have a single detent or slot 22, while others may have two or more, depending upon the configuration required to best apply to existing holding tank systems, where for example a second or third detent 22 may be spaced radially from the first detent or slot 122.

In some embodiments, such as system embodiment 10, the distribution member 14 comprises a chamber 24 that comprises a plurality of openings 26 disposed on preferably a side wall of the chamber 24, although openings on other walls of the chamber are contemplated. The openings 26 are configured preferably radially about the chamber 24 to permit the distribution of fluid to spray outwardly from the distribution member 14 when in use. The number and size of openings 26 may vary as desired in differing embodiments, depending upon the intended use.

Referring to FIG. 3, system 110 is shown as applied to an example of a bowl B and holding tank HT arrangement common in recreational vehicles. In this embodiment, system 110 comprises a unitary distribution member 114 and supply member 116, although the two could be manufactured separately, as shown in FIG. 1, but configured to be connectable so that they move in unison when connected and fed through the inner bore of sealing member 112. In either case, system 110 permits a user to control the depth that the distribution member 114 extends into the holding tank HT but pulling or pushing the supply member 116 upwardly or downwardly, respectively, during use. With embodiments, such as that shown in FIG. 1, the distribution member 14 and supply member 16 remain separate and the depth of the distribution member 14 is controlled merely by how far it extends into the inner bore of the sealing member 12.

Referring to FIG. 3, when in use, fluid (such as water) can be directed into the system 110 at arrow W1 for radial distribution generally orthogonally as shown at arrows W2, for example. The sealing member 112 is tapered in configuration to permit a sealed fit with an opening between the bowl B and holding tank HT to preclude any of the fluid that is directed into the holding tank to blow back toward the user, which is a recurring problem in prior art systems. When the sealing member 12 is applied to the bowl B and holding tank HT, fluid supply member 116 can be directed downwardly or upwardly to control the depth of distribution member 114 into the holding tank HT as desired. Moreover, where the configuration of the opening in the bowl connecting to the holding tank includes a valve (not shown), as it often does, detent 122 on the sealing member 112 can be oriented radially to engage a portion of the valve seat to further secure the sealing member 112 in place. As discussed above, embodiments of the present invention may include two or more detents or slots 122, where for example a second or third one may be spaced radially from the first detent or slot 122.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A holding tank cleaning system for minimizing the splatter of undesirable materials stored in the holding tank, where the holding tank is fluidly connected via a fluid passageway to a bowl into which waste material is deposited, the fluid passageway having a valve therein, the system comprising:
a sealing member having a generally frusto-conical shape and comprising an inner core for permitting the passage of fluid therethrough, the sealing member configured to connect to a source of fluid;
a supply member connectable to a source of fluid and configured to movably fit within the inner core of the sealing member; and
a distribution member configured to movably fit within the inner core of the sealing member, the distribution member comprising a distribution chamber comprising a plurality of openings such that fluid directed from the supply member through the sealing member into the distribution member can be directed radially outwardly in a direction generally perpendicular to the direction of fluid passing through the supply chamber.

2. The holding tank cleaning system of claim 1, wherein the distribution member is configured to be connectable to the supply member so that both can move in unison within the inner core of the sealing member.

3. The holding tank cleaning system of claim 1, wherein the supply member comprises a valve to regular the flow of fluid into the system.

4. The holding tank cleaning system of claim 1, wherein the sealing member comprises a detent for engaging a surface that extends radially inwardly from an outer surface of the sealing member.

5. The holding tank cleaning system of claim 4, wherein the sealing member comprises a plurality of detents.
